(19) United States
(12) Patent Application Publication
(10) Pub. No.: US 2008/0041711 A1
(43) Pub. Date: Feb. 21, 2008

(54) TOILET ILLUMINATION SYSTEM

(76) Inventor: PAUL G. HERBER, DALLAS, TX (US)

Correspondence Address: JESSICA W. SMITH, 1529 PARKVIEW DRIVE, GARLAND, TX, 75043, US

(21) Appl. No.: 11/838,988

(22) Filed: Aug. 15, 2007

Related U.S. Application Data
(60) Provisional application No. 60/822,507, filed on Aug. 15, 2006.

(51) Int. Cl. H01H 3/14

(52) U.S. Cl. 200/85 R

(57) ABSTRACT

A toilet illumination system has a pad that is formed in the shape of a mat for placement on the floor in the near proximity of the toilet. The pad includes an activation mechanism for activating and de-activating an illumination unit. When pressure is applied to the pad, such as a person stepping on the pad, the activation mechanism in the pad activates the illumination unit to illuminate the toilet. When pressure is released, the process is reversed, and the illumination unit turns off the illumination unit. Alternatively, pressure may be placed on a certain switch portion of the pad, such as a marked switch on the pad, to activate or deactivate the illumination unit.

### BACKGROUND OF THE INVENTION

1. Field of the Invention

This invention relates in general to accessories for toilets, and more particularly, a device that illuminates the toilet with easy activation.

2. Description of the Related Art

In general, one has to locate a light switch in order to activate a ceiling or other overhead light in a bathroom. Such a bright, overhead light may not be desirable, especially at night, in order to locate a toilet within a bathroom. In addition, it may be difficult or inconvenient to locate a light switch to activate the overhead light especially in an unfamiliar bathroom in the dark.

Other solutions have proposed switches or triggers located on the toilet that illuminate the back or sides of the toilet. These solutions have the disadvantage that one must still attempt to locate the switch or trigger for the light located on the toilet in the dark. In addition, in the process of locating the switch on the toilet in the dark, one may bump into the toilet or slip on a wet or slick tile bathroom floor.

Other solutions propose triggering a light by lifting the toilet bowl lid. Such solutions require a person's knowledge that a light will be triggered by lifting the lid. In addition, the lid must be closed to deactivate the light. And since toilet lids are often left in a raised position for convenience, the light will not be deactivated wasting batteries or electricity. This solution also requires locating the toilet in the dark and so still poses the danger of bumping into the toilet or slipping on a wet or slick tile floor.

Thus, there is a need for a toilet bowl illumination system with an easy to use and safe activation mechanism.

Accordingly, it is an object of the invention to provide a toilet illumination system with an easy to use activation mechanism.

It is another object of the invention to provide a toilet illumination system that is easily activated in the dark without having to locate a switch.

It is another object of the invention to provide additional safety feature to help prevent bumping into the toilet or slipping in the bathroom.

It is another object of the invention to provide an easy method for installing the toilet illumination system.

### BRIEF SUMMARY OF THE INVENTION

One embodiment of the invention comprises a pad that is formed in the shape of a mat for placement on the floor in the near proximity of the toilet. The pad includes an activation mechanism for activating and de-activating an illumination unit. When pressure is applied to the pad, such as a person stepping on the pad, the activation mechanism in the pad activates the illumination unit to illuminate the toilet. When pressure is released, the process is reversed, and the illumination unit turns off the light. Alternatively, pressure may be placed on a certain switch portion of the pad, such as a marked switch on the pad, to activate or deactivate the light.

### BRIEF DESCRIPTION OF THE SEVERAL VIEWS OF THE DRAWINGS

For a more complete understanding of the present invention, and the advantages thereof, reference is now made to the following descriptions taken in conjunction with the accompanying drawings, in which:

FIG. 1 illustrates an elevational view of one embodiment of the toilet illumination system.

FIG. 2 illustrates a pad in more detail used in one embodiment of the present invention.

FIG. 3 illustrates the illumination unit used in one embodiment of the present invention.

FIG. 4 illustrates a more detailed view of the clip used in the illumination unit of one embodiment of the invention.

FIG. 5 illustrates a more detailed view of the light unit used in an embodiment of the invention.

### DETAILED DESCRIPTION OF THE INVENTION

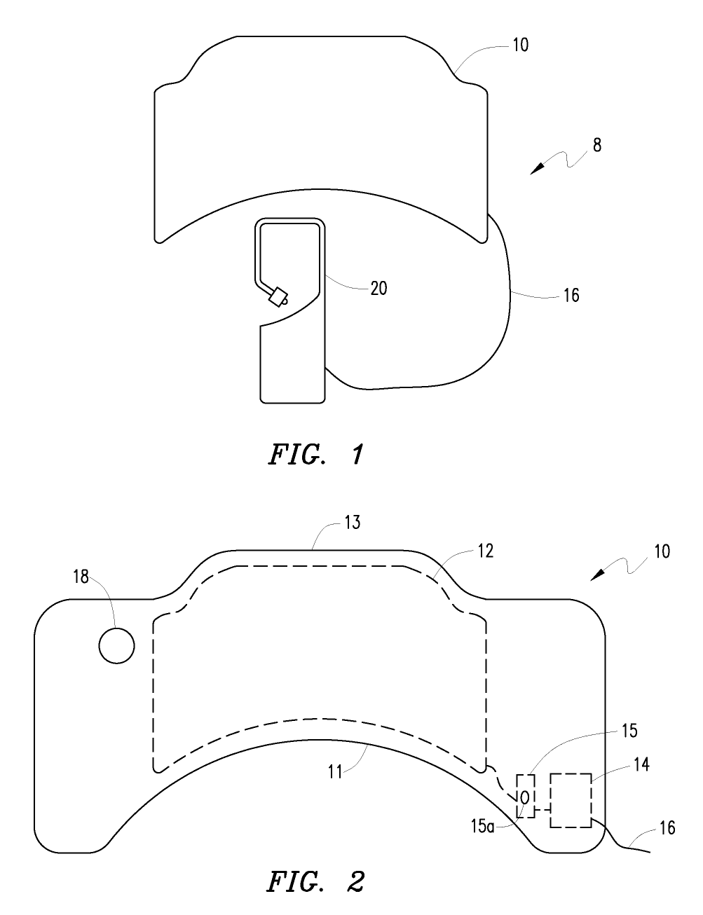

The present invention is best understood in relation to FIGS. 1 through 5 of the drawings, like numerals being used for like elements of the various drawings.

FIG. 1 illustrates an elevational view of one embodiment of the toilet illumination system 8. The toilet illumination system 8 includes an activation mechanism such as a pad 10, an illumination unit 20 and a cord 16 connecting the pad 10 and illumination unit 20.

FIG. 2 illustrates the pad 10 in more detail used in one embodiment of the toilet illumination system 8. The pad 10 is constructed of silicone or some other pliable water resistant or water proof material. In this embodiment, the pad 10 has a shape to fit around the base of a toilet or urinal. The concave side 11 of the pad 10 is shaped to fit adjacent to and around the base of the toilet or urinal. The length of the convex side 13 of the pad 10 is shaped to extend outward from the base of the toilet or urinal and preferably to extend further outwards on the floor than the toilet bowl or urinal from the wall. Thus, a person approaching a toilet or urinal, especially in a dark bathroom, will be able to touch or step onto the pad prior to bumping into the toilet. Of course, a person of skill in the art will understand that the pad 10 may be larger or smaller or have different shapes to align with different shaped toilets or urinals or even a bidet. The pad 10 may also have various different and decorative shapes from that shown in FIG. 1. The pad 10 may also be a bright or florescent color to further alert a person of the location of the toilet in a dark bathroom. The pad 10 may also comprise non-slip material or surface, such as ridges or other pattern, to prevent a person from slipping on a slick or wet floor. The pad 10 may also include a decorative sleeve that is in the same or similar shape and covers at least a portion of the pad 10. The pad 10 may also include decals or stickers that can be adhered to the surface. The decals or sticker may comprise a non-slip material or surface or provide decoration. Alternatively, decoration can be printed directly on the pad 10. Such decoration, either on a sleeve, sticker, or printed directly on the pad may include, for example, sports team names, logos and/or colors, decorative colors, prints, shapes or personalized pictures.

The pad 10 includes at least one activation mechanism 12. The activation mechanism 12 acts as a pressure activated switch for the toilet illumination system 8. The activation mechanism 12 is preferably located inside the pad 12 and is thus shown in dotted lines in FIG. 1. As a person of skill in the art would understand, the activation mechanism 12 may also be configured to reside underneath the pad 10 or on top of the pad 10 if desired.

The activation mechanism 12 in the pad 10 activates the illumination unit 20 in response to asserting pressure to any portion of a designated surface area of the pad. The designated surface area is preferably a majority portion of the surface area of the pad 10 for ease of use. Various devices may be used to construct activation mechanism 12, such as an electrical circuit that is closed by applied pressure to the pad 10. For example, when one applies pressure on the designated area of the activation mechanism 12 of the pad 10, a switch in an electrical circuit in the activation mechanism 12 is closed, and electrical current can flow to the illumination unit 20 to light the toilet. When pressure is released from the designated area, the switch in the electrical circuit in the activation mechanism 12 is open, the electrical current stops and the illumination unit 20 turns off.

The pad 10 may also include a battery pack 14 used to power the toilet illumination system 8. The battery pack 14 is electrically connected to the activation mechanism 12 in order to provide power to it. In addition, the battery pack 14 and activation mechanism 12 are connected by cord 16 to the illumination unit 20. The battery pack 14 is shown in dotted lines as inside the pad 10 but may also be located outside or adjacent to the pad 10. Alternatively, an electrical cord (not shown) may be used to connect activation mechanism 12 to an electrical outlet and a separate cord 16 used to connect activation mechanism 12 to illumination unit 20. The battery pack 14 may also be included in the illumination unit 20 or other places in the toilet illumination system 8.

In addition, pad 10 may include a switch 18 that is activated again by applied pressure to a designated area of pad 10. But unlike activation mechanism 12, switch 18 does not deactivate the illumination unit 20 when pressure is released. It must be pressed again to deactivate the illumination unit 20. A person of skill in the art would understand various stand switch devices in the market to implement switch 18. Switch 18 is preferably marked on the exterior surface of the pad 10, such as for example with a circle, or outline of a footprint or a symbol of a switch, to indicate to a user the location of the switch 18.

The switch 18 provides an alternative option for activating and deactivating the illumination unit 20. For example, if one desires a night light to remain on during the night or for extended period of time, switch 18 may be used to turn illumination unit 20 on even when pressure is released from the pad 10. When it is desired to turn off the illumination unit 20, the switch 18 may be pressed again.

Switch 18 may be used alone or activation mechanism 12 may be used alone with the pad 10 or both may be used on the same pad 10 to provide different options for activating and de-activating illumination unit 20. For example, one option may be as explained above that activation mechanism 12 activates the illumination unit 20 when pressure is applied and illumination unit 20 is de-activated once pressure is released from activation mechanism 12. Then switch 18 may be used to activate the illumination unit 20 even when pressure is not applied to the activation mechanism 12. The illumination unit 20 would activate upon triggering the switch 18 and remain activated until switch 18 is again triggered. Alternatively, activation mechanism 12 may activate the illumination unit 20 upon exertion of pressure and then the illumination unit 20 remains activated, even after pressure is released from activation mechanism 12, until switch 18 is triggered. Other options may also be configured for activating and de-activating illumination unit 20 with activation mechanism 12 and switch 18.

In addition, a timer circuit unit 15 may be connected between the activation mechanism 12 and/or switch 18 and the battery pack 14. The timer circuit unit 15 may be preset to a time period or adjustable by a user to a time period. For example, a time period of 5 minutes or 10 minutes may be preset upon manufacture or adjustable by a user with a time set input 15a. Upon release of pressure on the illumination unit 20 in response to pressure asserted on the activation mechanism 12, then the timer circuit unit 15 starts the time period. Upon expiration of the time period without further activation or pressure asserted on the activation mechanism 12, then the timer circuit unit 15 de-activates the illumination unit 20. Similarly if the switch 18 is activated and not deactivated within the time period, the timer circuit unit 15 de-activates the illumination unit 20. Thus, the timer circuit unit 15 saves battery power of the battery pack 14.

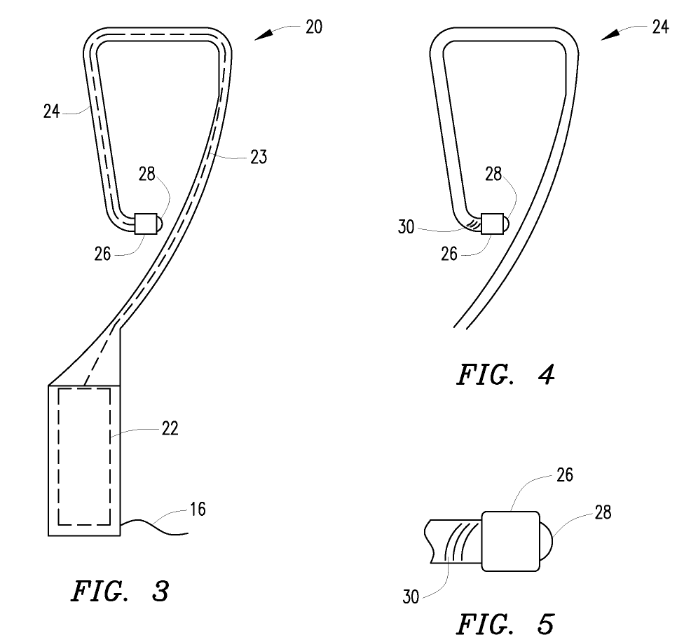

FIG. 3 illustrates an elevational view of an illumination unit 20 used in one embodiment of the invention. Illumination unit 20 includes a battery unit 22 connected to a clip 24. Clip 24 supports light unit 26 with LED 28. Illumination unit 20 is connected to the pad 10 by cord 16. Cord 16 provides the signals from activation mechanism 12 and switch 18 that triggers illumination unit 20 to activate and/or de-activate the light unit 26. Alternatively, pad 10 and illumination unit 20 may be connected by a wireless signal, such as an RFID signal. Such a wireless connection would be advantageous to reduce cords around the toilet.

The illumination unit 20 is powered by battery unit 22. Alternatively, illumination unit 20 may be powered by battery pack 14 in pad 10 or by a cord to an electrical outlet. In another embodiment, battery unit 22 may power the activation device 12 in the pad 10 and battery pack 14 would not be needed. Similarly, the timer circuit unit 15 may also be positioned in the illumination unit 20 between the activation mechanism 12 and the battery unit 22 rather than in the pad 10.

The illumination unit 20 includes a clip 24 that is shaped to fit around the contoured lip of a toilet bowl or under the edge of a urinal. When positioned over the lip of the toilet, the clip 24 holds the illumination unit 20 to the toilet. The clip 24 is preferably coated by a flexible plastic or other water resistant or water proof material. The clip 24 has an angle, such as approximately 90 degrees, to position the light unit to illuminate the toilet though other angles may be used as well. Though a clip 24 is shown to attach the illumination unit 20, any number of mechanisms may be used to connect the illumination unit 20 to the toilet bowl. In addition, though the clip 24 in FIG. 2 is designed to fit over the lip of the toilet bowl, other clips or attachment devices (Velcro, suction cups, etc.) may be used to fit around the toilet tank edges or lid or handle or other structure in or around the toilet to illuminate the toilet. The illumination unit 20 may also be built into the toilet.

At the end of clip 24, a light unit 26 holds an LED 28 for illuminating the toilet. The light unit 26 is connected to the battery unit 22 by wire 23. Wire 23 provides the signal to activate and de-activate the LED 28 in response to activation mechanism 12 and/or switch 18.

FIG. 4 illustrates a more detailed view of the clip 24 in the illumination unit 20 used in one embodiment of the present invention. The clip 24 may include a flexible neck or portion 30 that enables the light unit 26 to be positioned or angled in various directions. FIG. 5 provides a more detailed view of light unit 26, LED 28 and the flexible portion 30.

The toilet illumination system 8 has an activation mechanism that is easy to use by stepping on or applying pressure to the pad 10. Since the pad 10 extends from the toilet or urinal, it helps prevent bumping into the toilet or urinal or falls from slipping on a wet or slick tile floor. The pad 10 may also be a bright or florescent color to further alert a person of the location of the toilet.

The toilet illumination system 8 may also provide an incentive device in the toilet training of toddlers. By illuminating the toilet when a child applies pressure on the pad 10, the child has positive feedback for approaching the toilet. A child may delight in turning on the light and provide motivation for toilet training.

The toilet illumination system 8 may also be used for other purposes. For example, the pad 10 may be placed in a baby's room by a crib or changing table with the illumination unit 20 hung on the crib or by the changing table. This arrangement would help parents entering a baby's room at night without having to turn on a bright light. Another use of the toilet illumination system may be for a tent for camping. For example, the illumination unit 20 may be hung in the tent or near a tent and the pad 10 placed at the entrance to the tent or outside the tent entrance to help campers enter or leave the tent at night. Thus, campers need not find a flashlight or other light switch in the dark. Of course, the pad 10 and illumination unit 20 may be placed in other places that would assist campers at night. In addition, the toilet illumination unit 20 may be used for working in dark spaces, such as underneath a car. A person may need more light to work under a car—especially in a poorly lit garage or at night.

Since the toilet illumination system 8 works with batteries, it is very portable and may be used in many other situations without need for plugs. This advantage allows for increased safety in damp conditions, such as a bathroom or tent floor.

Although the Detailed Description of the invention has been directed to certain exemplary embodiments, various modifications of these embodiments, as well as alternative embodiments, will be suggested to those skilled in the art. The invention encompasses any modifications or alternative embodiments that fall within the scope of the claims.

1. A toilet illumination system, comprising:
an illumination unit for illuminating a toilet;
an activation mechanism for placement on the floor in the near proximity of the toilet for activating and deactivating the illumination unit in response to pressure applied to the activation mechanism.

2. The toilet illumination system of claim 1, wherein the activation mechanism is included in a pad on the floor and activates the illumination unit in response to asserting pressure to any portion of a designated surface area of the pad.

3. The toilet illumination system of claim 2, wherein the activation mechanism de-activates the illumination unit in response to releasing pressure from a designated surface area of the pad.

4. The toilet illumination system of claim 3, wherein the illumination unit includes a clip for attaching over the lip of a toilet bowl.

5. The toilet illumination system of claim 4, wherein the illumination unit includes a light unit at the end of the clip.

6. The toilet illumination system of claim 5, wherein the clip includes a flexible neck to adjust an angle of the light unit.

7. The toilet illumination system of claim 1, wherein the illumination unit and the pad are connected by an electrical conducting cord.

8. The toilet illumination system of claim 1, wherein the illumination unit and the pad are connected by a wireless interface.

9. The toilet illumination system of claim 3, wherein the toilet illumination system further includes:
a switch able to activate the illumination unit even when no pressure is exerted on the activation mechanism.

10. The toilet illumination system of claim 2, wherein the pad on the floor comprises decoration.

11. A method for illuminating a toilet, comprising:
activating a toilet illumination unit in response to applying pressure to a pad positioned near the toilet, wherein the toilet illumination unit is attached to the toilet by a clip and is powered by a battery; and
deactivating the toilet illumination unit in response to releasing pressure from the pad.

12. The toilet illumination system of claim 10, further comprising:
applying decoration to the pad, wherein the decoration comprises one of the following:
a sticker or sleeve

13. A toilet illumination system, comprising:
an illumination unit for illuminating a toilet, wherein the illumination unit is attached to the toilet by a clip;
a pad positioned on a floor in proximity to the toilet that activates the illumination unit; and
a battery pack that powers the illumination unit in response to a signal from the pad.

14. The toilet illumination system of claim 13, wherein the illumination unit further comprises:
a light unit; and
wherein the clip has an an angle to illuminate the toilet with the light unit.

15. The toilet illumination system of claim 13, wherein the pad comprises the battery pack that is conductively connected to the illumination unit to power the light unit.

16. The toilet illumination system of claim 15, wherein the pad activates the illumination unit in response to pressure applied to a designated portion of a surface of the pad.

17. The toilet illumination system of claim 16, wherein the pad de-activates the illumination unit in response to pressure released from a designated portion of a surface of a pad.

18. The toilet illumination system of claim 16, wherein the illumination unit is de-activated in response to expiration of a time period set by a timer circuit.

19. The toilet illumination system of claim 14, wherein the illumination unit includes a battery pack.

20. The toilet illumination system of claim 13, wherein the illumination unit and the pad are connected by a wireless interface.
